(19) United States
(12) Patent Application Publication
(10) Pub. No.: US 2020/0399935 A1
(43) Pub. Date: Dec. 24, 2020

(54) TETHERED HOLDER FOR AMENITY ITEM

(71) Applicant: Randall Dayle Carr, JR., Costa Mesa, NY (US)

(72) Inventor: Randall Dayle Carr, JR., Costa Mesa, NY (US)

(21) Appl. No.: 16/946,461

(22) Filed: Jun. 23, 2020

Related U.S. Application Data
(60) Provisional application No. 62/865,504, filed on Jun. 24, 2019.

(51) Int. Cl. E05B 73/00; A47K 3/28; A47K 5/02

(52) U.S. Cl. CPC E05B 73/0041; A47K 3/281; A47K 2201/025; B65D 2211/00; A47K 5/02

(57) ABSTRACT

A bracket that holds an aromatherapy product, or other amenity item, in a shower, with an integrated security “leash” that keeps the bottle from being stolen. The combination of the bracket with the integrated leash solves a security/theft problem for the customer using the bracket. The present invention provides a unique way to attach a leash and collar to the bottle so it can be secured and not stolen from the shower where the bracket system is used.

### CROSS-REFERENCE TO RELATED APPLICATION

This application claims the benefit of priority of U.S. provisional application No. 62/865,504 filed Jun. 24, 2019, the contents of which are herein incorporated by reference.

### BACKGROUND OF THE INVENTION

The present invention relates to amenity items, and more particularly to holders for amenity items.

Amenity items such as shampoos, soaps, shower gels, and aroma therapy dispensers may be made available to patrons at spas, fitness centers, and the like, where shower facilities are provided for the patron following their session. Some amenity items are provided for patron use in the shower facility. However, theft of bottles of amenity items in spa showers is a recurring challenge.

In the spa industry where hotels have spas on property for guest use, theft of the amenity item is a major problem with almost all amenity items being subject to theft.

As can be seen, there is a need for an improved anti-theft bracket for holding bottled amenity items in a spa shower.

### SUMMARY OF THE INVENTION

In one aspect of the present invention, a tethered holder for an amenity item dispenser bottle is disclosed. The tethered holder includes a holder bracket having a vertical face. A base extends from a bottom of the holder bracket. A retainer fork protrudes from a top end of the holder bracket. The retainer fork has an arcuate face adapted to receive an outer surface of the dispenser bottle. A tether band is adapted to clamp around a bottom of the dispenser bottle. A tether is operatively coupled to each of the holder bracket and the tether band to secure the dispenser bottle to the tethered holder.

In some embodiments, the base has an arcuate peripheral edge. Terminal ends of the retainer fork may also have an arcuate edge.

In some embodiments, an aft end of the vertical face is configured to removably mount to a wall structure. an adhesive strip applied to the aft end of the vertical face.

In some embodiments a tab defined at terminal ends of the tether band. At least one aperture is defined in a face of each tab. The at least one aperture is axially aligned with a corresponding at least one aperture when the tether band is positioned to encircle the dispenser bottle. A fastener extends through the at least one aperture and the corresponding aperture, the fastener operable to clamp the tether band about the dispenser bottle.

In some embodiments, the at least one aperture and the at least one corresponding aperture may also receive a first end of the tether therethrough. A fastener may secure the first end of the tether to the tether band.

In other embodiments, a hole is defined proximal to a junction between the vertical face and the base. A fastener secures a second end of the tether in the hole.

In other embodiments, dispenser bottle is included. The dispenser bottle is formed of a rigid material selected from the group consisting of aluminum, stainless steel, and plastic. A dispensing cap is removably coupled to a top end of the dispenser bottle.

In yet other embodiments, an amenity product selected from the group consisting of an aroma therapy product, a shower gel, a shampoo, a conditioner, and a personal hygiene product is contained within an interior cavity of the dispenser bottle.

These and other features, aspects and advantages of the present invention will become better understood with reference to the following drawings, description and claims

### BRIEF DESCRIPTION OF THE DRAWINGS

FIG. 1 is a perspective view of the tethered amenity holder, shown in use installed in a shower enclosure.

FIG. 2 is a front perspective exploded view of the tethered amenity holder.

FIG. 3 is a detail exploded view of the clamp 30 and fasteners 44 and 46.

FIG. 4 is a rear perspective exploded view of the tethered amenity holder.

FIG. 5 is a section view of the tethered amenity holder, taken along line 5-5in FIG. 1, with bottle 48 shown as hidden for clarity.

FIG. 6 is a section view of the tethered amenity holder, taken along line 6-6 in FIG. 5.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

Broadly, embodiments of the present invention provides a system, method, and apparatus for providing an anti-theft holder bracket for presenting a dispenser bottle of an amenity item in a shower enclosure or vanity area of a spa or other hospitality industry accommodation.

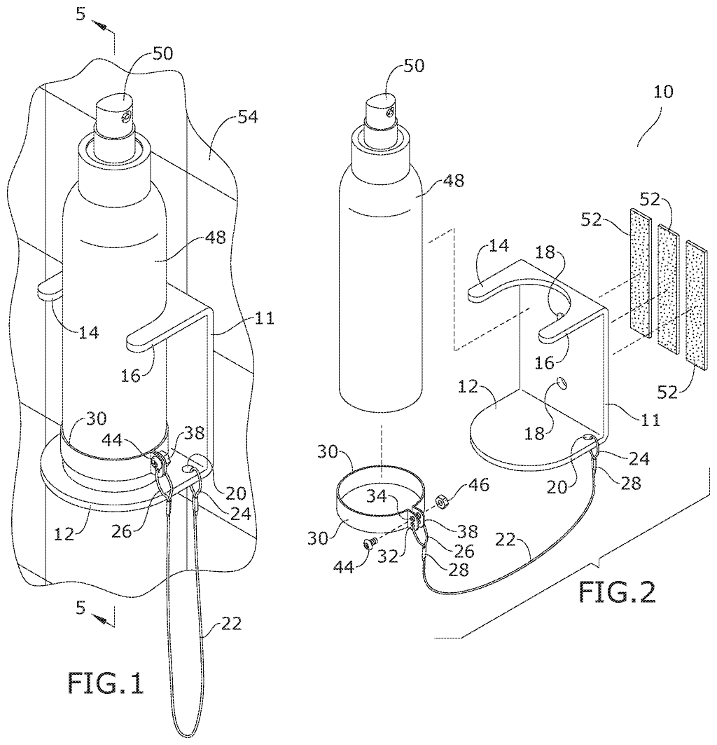

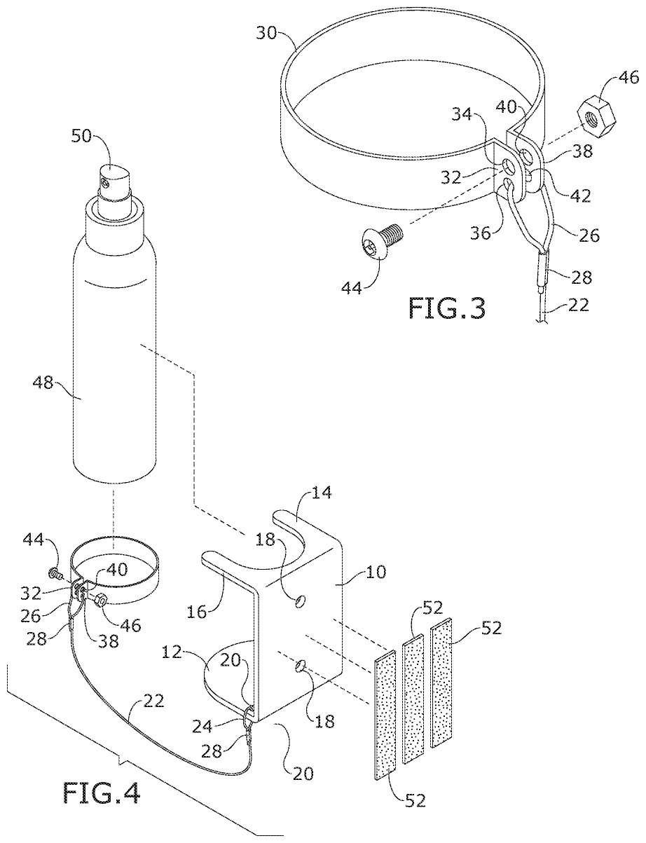

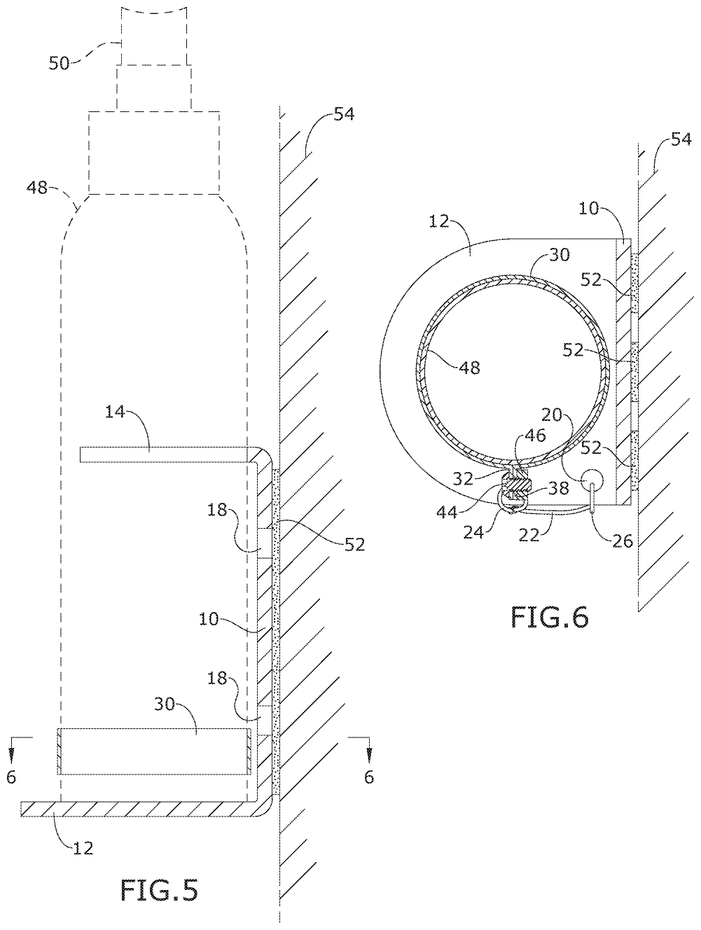

As seen in reference to the drawings of FIGS. 1-5, the anti-theft dispenser holder of the present invention includes a bracket holder 10, a tether 22, and a tether band 30. The tether band 30 is applied to a dispenser bottle 48 that is filled with an amenity item. The tether band 30 is dimensioned to encircle a bottom end of the dispenser bottle. The tether band 30 has a fastener, such as a screw 44 and a nut 46 that are received through axial aligned apertures 34, 40 defined in a clamping tab defined at ends of the tether band 30. Once secured by the fasteners 44, 46, the tether band 30 tightly clamps the tether band 30 about the dispenser bottle 48.

The tether 22 includes a cable that has a first end secured to a hole 36, 42 in abutting faces of the tether band 30 via a fastener clamp 28 and a second end that is secured to the bracket holder 10 by a fastener clamp 28, such as a crimp fastener. The tether 22 has a length that allows the patron to readily dispense the amenity item while within the shower enclosure 54. Preferably, the tether 22 is formed of a stainless steel or other corrosion resistant material suitable for use in a wet environment.

When installed in a customer service environment, the anti-theft holder 10 is replaced at periodic intervals to keep the appearance of the bracket holder 10 and accoutrements in a clean and fresh condition. Accordingly, the bracket holder 10 has a mounting plate 11 that is attachable to a wall surface 54 via a water resistant adhesive, or adhesive strip 52. The adhesive 52 is selected so that it is removable at the specified interval without marring or damaging the shower enclosure wall 54 surface. For more permanent mounting, a plurality of mount holes 18 are provided to receive a screw or other fastener to mount the holder bracket 10 to the shower enclosure wall 54.

A holder bracket base 12 protrudes from a bottom end of the mounting plate 11. The holder bracket base 12 is dimensioned to support a bottom end of the dispenser bottle 48. The holder bracket base 12 may have an arcuate peripheral edge to avoid presenting a strike hazard in the event the gust slips. In a preferred embodiment, the second end of the tether 22 is attached to the holder bracket base 12 through a hole 20 proximal to the adjoining surface with the mounting plate 11 so that the bottle 48 doesn't rest upon the tether 22 and topple.

A retaining fork 14, 16 is provided that protrudes outwardly at a top end of the mounting plate 11. The retaining fork 14, 16 has an arcuate face that is dimensioned to correspond to a radius of the dispenser bottle 48 at an intermediate portion of the dispenser bottle 48. Terminal ends of the retaining fork 14, 16 have an arcuate edge surface to avoid presenting a strike hazard. The retaining fork 14, 16 is an improvement over prior art bottle holders in that the user no longer needs to guide the bottle 48 vertically through a top circular opening. The retaining fork 14, 16 also permits the tether band 30 to be coupled to the dispenser bottle 48 at a bottom end so that the tether band 30 and tether 22 avoid interfering with the customer's use and dispensing of the amenity product carried in the dispenser bottle 48.

In a preferred embodiment, the dispenser bottle 48 is formed of a rigid aluminum, stainless steel, metallic container vessel 48. The dispenser bottle 48 has a removable dispenser cap 50, such as a spray, pump, or pour type cap, such that the dispenser bottle 48 refillable. The dispenser bottle 48 may be filled and refilled with an amenity item selected from the group consisting of an aroma therapy product, a shower gel, a shampoo, a conditioner, or other personal hygiene product.

In use, the holder bracket 10 of the present invention is attached to the wall 54 in shower or other vanity area. With the holder bracket 10 attached to wall 54 in shower, the bottle 48 is available to spray or dispense the amenity item in the shower environment. The bottle 48 is held secure to the holder bracket 10 by the tether 22 and the tether clamp 30. Once the holder bracket 10 is applied to the wall 48, the bottle 48 is filled with product and used by guests in the shower. Once the guest has dispensed a desired quantity of amenity product, the bottle 48 is then placed on the bracket base 12, The bottle 48 is not removed or stolen because the tether 22 mechanically connects the bottle 48 to the bracket 10. The bottle 48 is held secure to the bracket 10 by the tether 22 and the tether clamp 30, which also prevents the guest from dropping the bottle 48 in the shower enclosure.

It should be understood, of course, that the foregoing relates to exemplary embodiments of the invention and that modifications may be made without departing from the spirit and scope of the invention,

What is claimed is:

1. A tethered holder for securely retaining a dispenser bottle for dispensing an amenity item, comprising:
a holder bracket having a vertical face, a base extending from a bottom of the holder bracket, a retainer fork protruding from a top end of the holder bracket, the retainer fork having an arcuate face adapted to receive an outer surface of the dispenser bottle;
a tether band adapted to clamp around a bottom of the dispenser bottle; and
a tether operatively coupled to each of the holder bracket and the tether band to secure the dispenser bottle to the tethered holder.

2. The tethered holder of claim 1, wherein the base has an arcuate peripheral edge.

3. The tethered holder of claim 1, wherein terminal ends of the retainer fork have an arcuate edge.

4. The tethered holder of claim 1, wherein an aft end of the vertical face is configured to removably mount to a wall structure.

5. The tethered holder of claim 4, further comprising:
an adhesive strip applied to the aft end of the vertical face.

6. The tethered holder of claim 1, further comprising:
a tab defined at terminal ends of the tether band;
at least one aperture defined in a face of each tab and is axially aligned with a corresponding at least one aperture when the tether band is positioned to encircle the dispenser bottle.

7. The tethered holder of claim 6, further comprising:
a fastener extending through the at least one aperture and the corresponding aperture, the fastener operable to clamp the tether band about the dispenser bottle.

8. The tethered holder of claim 6, wherein the at least one aperture and the at least one corresponding aperture receive a first end of the tether therethrough.

9. The tethered holder of claim 8, further comprising:
a fastener to secure the first end of the tether to the tether band.

10. The tethered holder of claim 9, further comprising:
a hole defined proximal to a junction between the vertical face and the base; and
a fastener to secure a second end of the tether in the hole.

11. The tethered holder of claim 10, further comprising:
the dispenser bottle formed of a rigid material selected from the group consisting of aluminum, stainless steel, and plastic; and
a dispensing cap removably coupled to a top end of the dispenser bottle.

12. The tethered holder of claim 10, further comprising:
an amenity product selected from the group consisting of an aroma therapy product, a shower gel, a shampoo, a conditioner, and a personal hygiene product contained within an interior cavity of the dispenser bottle.
